(19) United States
(12) Patent Application Publication
(10) Pub. No.: US 2015/0309310 A1
(43) Pub. Date: Oct. 29, 2015

(54) HEAD MOUNTED DISPLAY DEVICE DISPLAYING THUMBNAIL IMAGE AND METHOD OF CONTROLLING THEREFOR

(71) Applicant: LG ELECTRONICS INC., Seoul (KR)

(72) Inventors: Eunhyung CHO, Seoul (KR); Sihwa PARK, Seoul (KR)

(73) Assignee: LG ELECTRONICS INC., Seoul (KR)

(21) Appl. No.: 14/289,356

(22) Filed: May 28, 2014

(30) Foreign Application Priority Data
Apr. 23, 2014 (KR) 10-2014-0048530

(51) Int. Cl. G02B 27/01; H04N 5/445; H04N 7/18

(52) U.S. Cl. CPC G02B 27/017; H04N 7/18; H04N 5/445

(57) ABSTRACT

The present specification relates to a head mounted display device and a method of controlling therefor.

According to one embodiment of the present specification, a method of controlling a HMD device includes the steps of displaying a part of a surround video image, if a front direction of the HMD device corresponds to a first direction, displaying a first region among the surround video image and if the front direction of the HMD device corresponds to a second direction, displaying a second region among the surround video image, and displaying a thumbnail image related to the surround video image and a progress bar indicating a progress status of the surround video image, wherein the thumbnail image includes a first image corresponding to the first region of the surround video image and a second image corresponding to the second region of the surround video image.

This application claims the benefit of the Korean Patent Application No. 10-2014-0048530, filed on Apr. 23, 2014, which is hereby incorporated by reference as if fully set forth herein.

### BACKGROUND OF THE INVENTION

1. Field of the Invention

The present specification relates to a head mounted display device and a method of controlling therefor.

2. Discussion of the Related Art

A head mounted display (hereinafter abbreviated HMD) device may provide a virtual reality image to a user. More specifically, the HMD device may be classified into an open-view type enabling the user to see both information on a real object in real world and the virtual reality image and a closed-view type enabling the user to see the virtual reality image only. In case of the HMD device of the closed-view type, the HMD device may differently configure images provided to the user according to a front direction of the HMD device. More specifically, in case of the HMD device of the open-view type, the user may see a different landscape in accordance with a gaze direction of the user. Similar to this, the HMD device of the closed-view type, the HMD device may provide the user with a different image according to the front direction of the HMD device.

Additionally, the HMD device may play a video content as a virtual reality image. In this case, the video content may include a video image corresponding to time information. The HMD device may display a progress bar indicating progress status of the video content. Additionally, the HMD device may display a thumbnail image related to the video image in the progress bar.

In case that the HMD device displays the progress bar and the thumbnail image, it is required to have a method for the HMD device to display a thumbnail image for a virtual reality image, which is differently provided depending on the front direction of the HMD device.

### SUMMARY OF THE INVENTION

Accordingly, the present specification is directed to an apparatus and method thereof that substantially obviate one or more problems due to limitations and disadvantages of the related art.

The present specification intends to provide an HMD device displaying a thumbnail image and a method of controlling therefor.

According to one embodiment, one object of the present specification is to provide a method for an HMD device to display a thumbnail image based on an image type of a surround video image.

According to one embodiment, another object of the present specification is to provide a method for an HMD device to display a thumbnail image based on a display attribute of the thumbnail image.

According to one embodiment, another object of the present specification is to provide a method for an HMD device to display a thumbnail image in a location corresponding to time information in a progress bar.

According to one embodiment, another object of the present specification is to provide a method for an HMD device to include a main region and a sub region.

According to one embodiment, another object of the present specification is to provide a method for an HMD device to include a main image of a thumbnail image.

According to one embodiment, the other object of the present specification is to provide a method for an HMD device to control a thumbnail image using a progress bar.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, according to one embodiment, a head mounted display (HMD) device may include a sensor unit configured to detect a front direction of the HMD device, a display unit configured to display a part of a surround video image according to the front direction of the HMD device, if the front direction of the HMD device corresponds to a first direction, the display unit configured to display a first region among the surround video image and if the front direction of the HMD device corresponds to a second direction, the display unit configured to display a second region among the surround video image, and a processor configured to control the sensor unit and the display unit, the processor configured to display a thumbnail image related to the surround video image and a progress bar indicating a progress status of the surround video image, wherein the thumbnail image includes a first image corresponding to the first region of the surround video image and a second image corresponding to the second region of the surround video image.

Accordingly, the present specification provides the following effects or advantages.

According to the present specification, it may provide an HMD device displaying a thumbnail image and a method of controlling therefor.

According to the present specification, an HMD device may display a thumbnail image based on an image type of a surround video image.

According to the present specification, an HMD device may display a thumbnail image based on a display attribute of the thumbnail image.

According to the present specification, an HMD device may display a thumbnail image in a location corresponding to time information in a progress bar.

According to the present specification, an HMD device may include a main region and a sub region.

According to the present specification, an HMD device may include a main image of a thumbnail image.

According to the present specification, an HMD device may control a thumbnail image using a progress bar.

It is to be understood that both the foregoing general description and the following detailed description of the present specification are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram for an HMD device according to one embodiment of the present specification;

FIG. 2a to FIG. 2c are diagrams for an image type of a surround video image according to one embodiment of the present specification;

FIG. 3 is a diagram for a region displayed according to a front direction of an HMD device among a surround video image according to one embodiment of the present specification;

FIG. 4a to FIG. 4c are diagrams of a method for an HMD device according to one embodiment of the present specification to display a thumbnail image based on an image type of a surround video image;

FIG. 5a to FIG. 5c are diagrams of a method for an HMD device according to one embodiment of the present specification to display a thumbnail image based on a display attribute of a thumbnail image;

FIG. 6 is a diagram of a method for an HMD device according to one embodiment of the present specification to change a region displayed in a front direction of the HMD device based on a control input;

FIG. 7 is a diagram of a method for an HMD device according to one embodiment of the present specification to display a thumbnail image including a main region;

FIG. 8a to FIG. 8c are diagrams of a method for an HMD device according to one embodiment of the present specification to change an image displayed in a main region;

FIG. 9a to FIG. 9c are diagrams of a method for an HMD device according to one embodiment of the present specification to display a thumbnail image adjacent to a progress bar based on time information of the thumbnail image;

FIG. 10a and FIG. 10b are diagrams of a method for an HMD device according to one embodiment of the present specification to display a thumbnail image based on a progress bar;

FIG. 11a and FIG. 11b are diagrams of a method for an HMD device according to one embodiment of the present specification to control a thumbnail image using a progress bar;

FIG. 12 is a flowchart for a method of controlling an HMD device according to one embodiment of the present specification.

### DETAILED DESCRIPTION OF THE INVENTION

While embodiments have been described in detail with reference to the attached drawings and contents written on the drawings, the scope of claims may be non-restricted or non-limited by the embodiments.

Although terminologies used in the present specification are selected from general terminologies used currently and widely in consideration of functions, they may be changed in accordance with intentions of technicians engaged in the corresponding fields, customs, advents of new technologies and the like. Occasionally, some terminologies may be arbitrarily selected by the applicant(s). In this case, the meanings of the arbitrarily selected terminologies shall be described in the corresponding part of the detailed description of the specification. Therefore, terminologies used in the present specification need to be construed based on the substantial meanings of the corresponding terminologies and the overall matters disclosed in the present specification rather than construed as simple names of the terminologies.

A head mounted display device (hereinafter abbreviated HMD device) of the present specification may provide an image to a user. More specifically, the HMD device 100 may provide the image to the user wearing the HMD device 100. In this case, the image may correspond to a video image or a stationary image including time information.

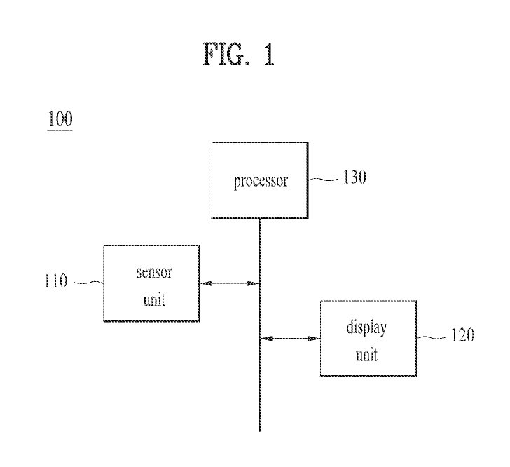

FIG. 1 is a block diagram for an HMD device according to one embodiment of the present specification. The HMD device 100 may include a sensor unit 110, a display unit 120 and a processor 130.

The sensor unit 110 may detect a front direction of the HMD device 100. In this case, the front direction of the HMD device 100 may correspond to a direction at which a gaze of a user wearing the HMD device 100 is facing. More specifically, the front direction of the HMD device 100 is a direction which is changed based on a movement of the user wearing the HMD device 100 and may be determined on the basis of the HMD device 100. In particular, the front direction of the HMD device 100 may correspond to a direction at which the user is looking while the user is wearing the HMD device 100. Additionally, the HMD device 100 sets up a reference direction for the front direction of the HMD device 100 and may be then able to detect that the front direction of the HMD device 100 is changing. As an example, the HMD device 100 may set up a direction at which the user is looking on timing that the user is wearing the HMD device 100 as the reference direction. In this case, if the user wearing the HMD device 100 turns the user's head or moves, the HMD device 100 may detect a change of the front direction of the HMD device 100 based on the reference direction on the timing that the user is wearing the HMD device 100.

Additionally, the HMD device 100 may set up the reference direction when the user wearing the HMD device 100 plays a video content including a surround video image. As an example, if the user wearing the HMD device 100 plays a movie content to watch a movie, the HMD device 100 may detect a front direction of the HMD device 100 on timing of playing the video content. In this case, if the user turns the user's head or moves, the HMD device 100 may detect that the front direction of the HMD device 100 is changing on the basis of the reference direction. In particular, the front direction of the HMD device 100 can be detected based on the reference direction. Additionally, the reference direction may be differently determined by the user or the HMD device 100, by which the present specification may be non-limited.

Additionally, the sensor unit 110 detects a control input and may deliver the detected control input to the processor 130. In this case, the control input may correspond to an input for controlling the HMD device 100. More specifically, the control input may correspond to an input for controlling a progress bar displayed in the HMD device 100, a thumbnail image and a surround video image. In this case, the sensor unit 110 may detect at least one selected from the group consisting of a gesture input, a touch input, an audio input and an input inputted by an input device as the control input. In particular, the sensor unit 110 may detect the control input for controlling the progress bar displayed in the MID device 100, the thumbnail image and the surround video image, by which the present specification may be non-limited. Additionally, the sensor unit 110 may include at least one selected from the group consisting of a touch sensor, a proximity sensor, a gyro sensor, an acceleration sensor, a gravity sensor and a voice recognition sensor, by which the present specification may be non-limited.

Additionally, the aforementioned sensors may be included in the HMD device 100 as a separate element or may be included in the HMD device in a manner of being integrated into more than one or more elements.

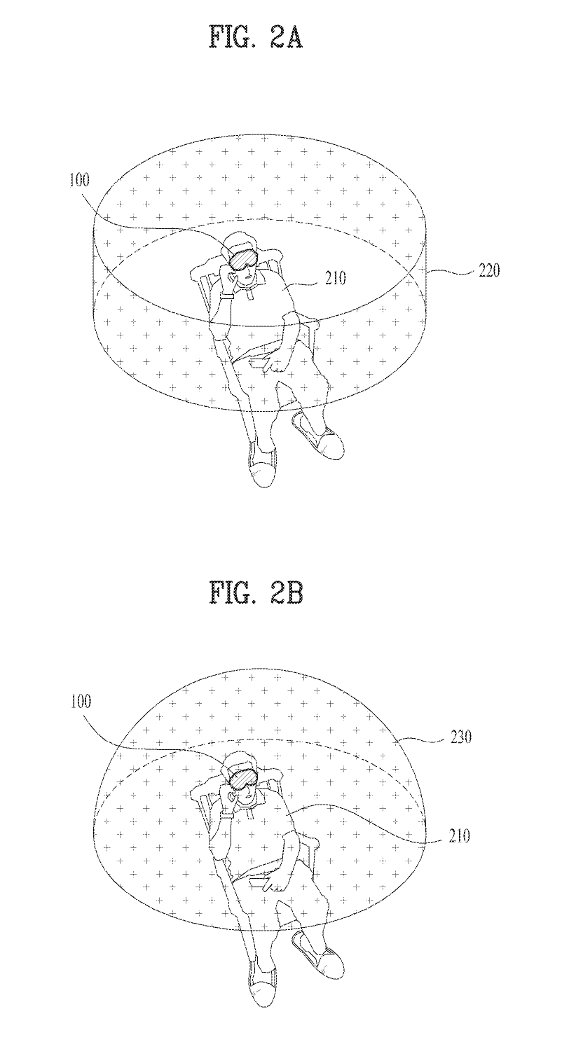

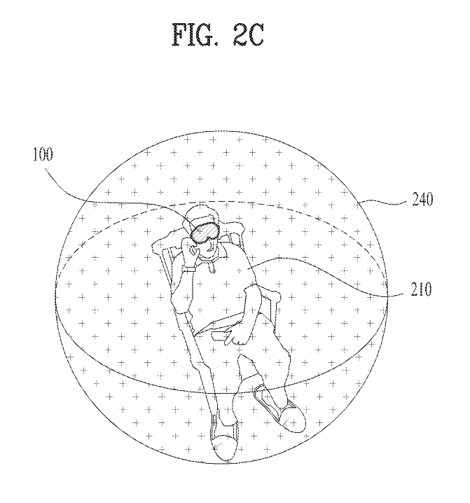

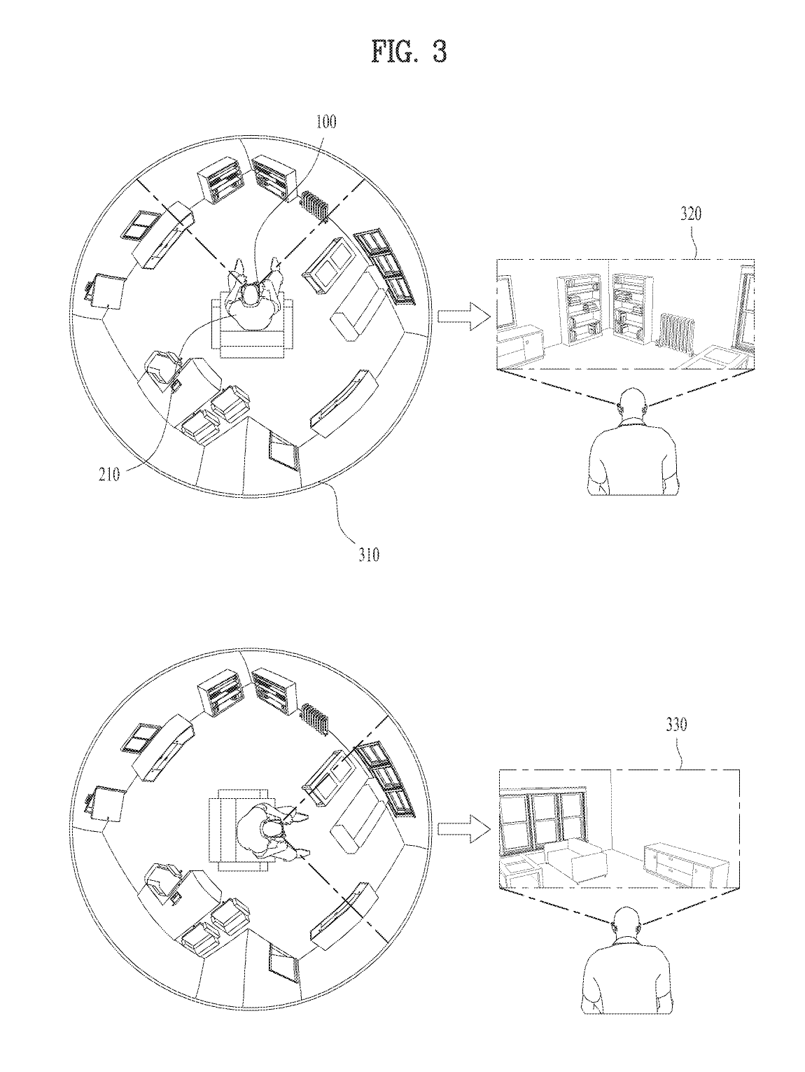

The display unit 120 may display a surround video image. In this case, the surround video image may correspond to such visually recognizable information as an image, a text, a video, a photo, a picture and the like. Additionally, the surround video image may correspond to an image in which a different region is displayed based on a front direction of the HMD device 100. Regarding this, it shall be described later with reference to FIG. 2a to FIG. 2c. Additionally, the surround video image may be an image corresponding to time information. More specifically, the surround video image may be an image corresponding to the time information in surround video content. As an example, the surround video content may correspond to a captured image, a movie or the like. In particular, the surround video image may correspond to an image corresponding to the time information in the surround video content.

The display unit 120 may display a progress bar and a thumbnail image. In this case, the progress bar may indicate a progress status of a surround video image. More specifically, the progress bar may indicate the progress status based on time information of the surround video image within surround video content. Additionally, as an example, the progress bar may display an indicator in a position corresponding to the time information of the surround video image. In this case, the progress bar may display the surround video image based on the time information of a point at which the indicator is positioned. In particular, the progress bar may include information on the progress status of the surround video image. Additionally, the display unit 120 may display a thumbnail image. In this case, the thumbnail image may correspond to an image corresponding to the surround video image. More specifically, the thumbnail image may correspond to an image reduced from the surround video image with a reference ratio. Additionally, the thumbnail image is an image related to the surround video image and may correspond to a representative image of the surround video image. Additionally, the display unit 120 may display the thumbnail image adjacent to a position corresponding to the time information in the progress bar. More specifically, the thumbnail image may include the time information within the surround video image. In this case, the display unit 110 may display the thumbnail image adjacent to the progress bar as the position corresponding to the time information included in the thumbnail image.

Additionally, as an example, the display unit 120 may display the surround video image, the thumbnail image and the progress bar at the same time. More specifically, in case that the HMD device 100 displays the surround video image, the HMD device 100 may display the time information of the surround video image via the progress bar. Additionally, the HMD device 100 may display the thumbnail image in a position adjacent to the progress bar as a position corresponding to the time information of the surround video image. In particular, in case that the HMD device 100 displays the surround video image, the HMD device 100 may display the progress bar and the thumbnail image at the same time.

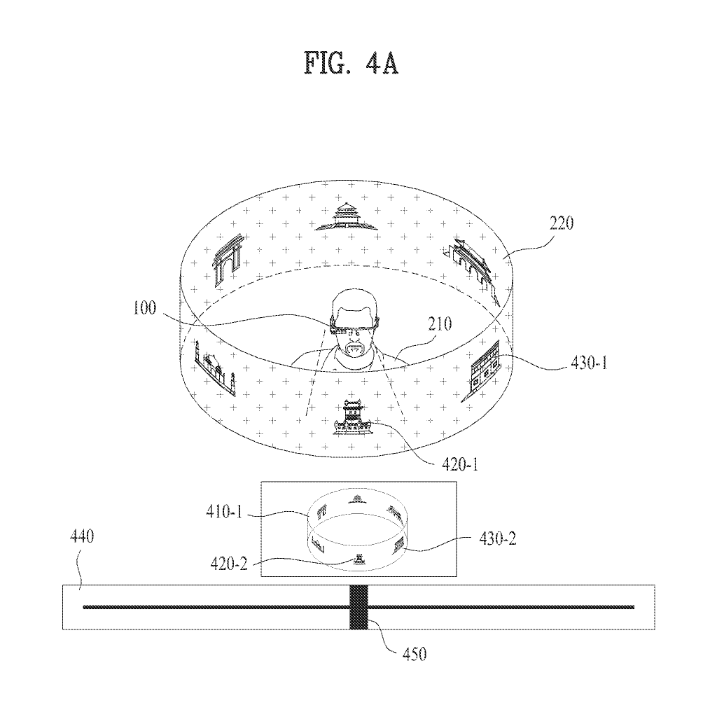

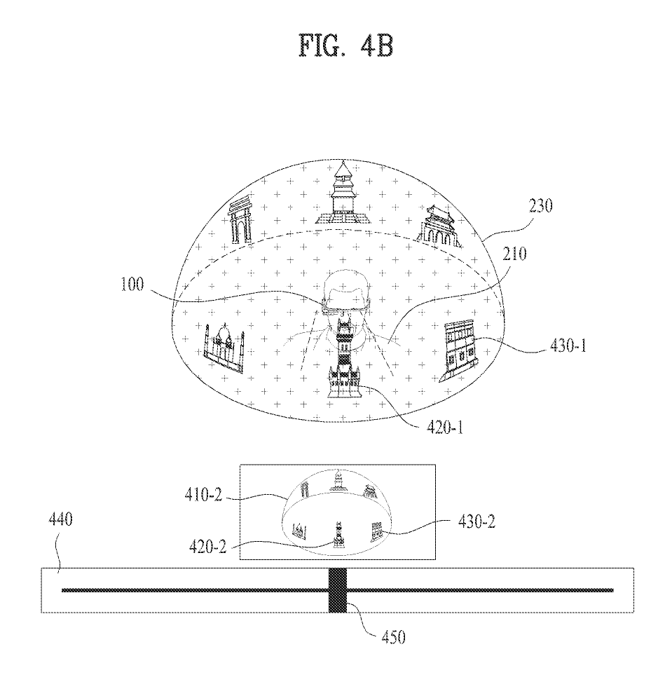

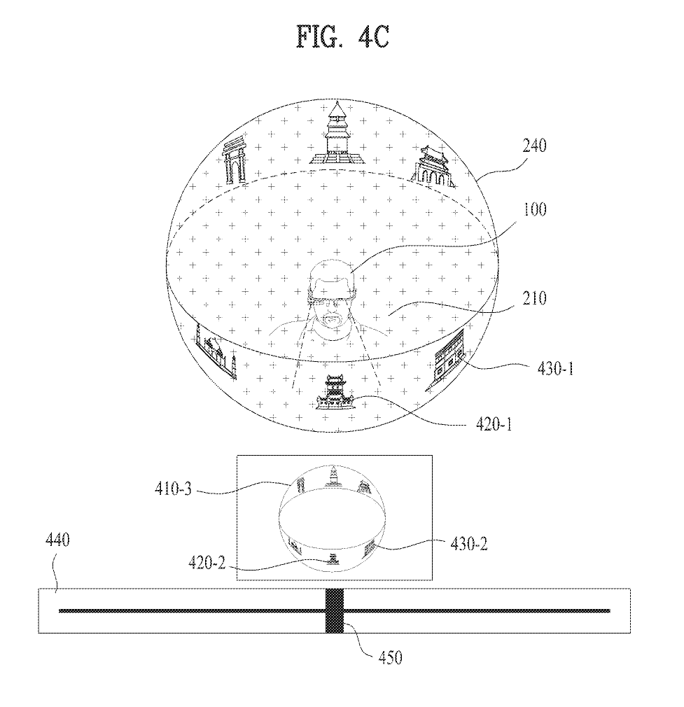

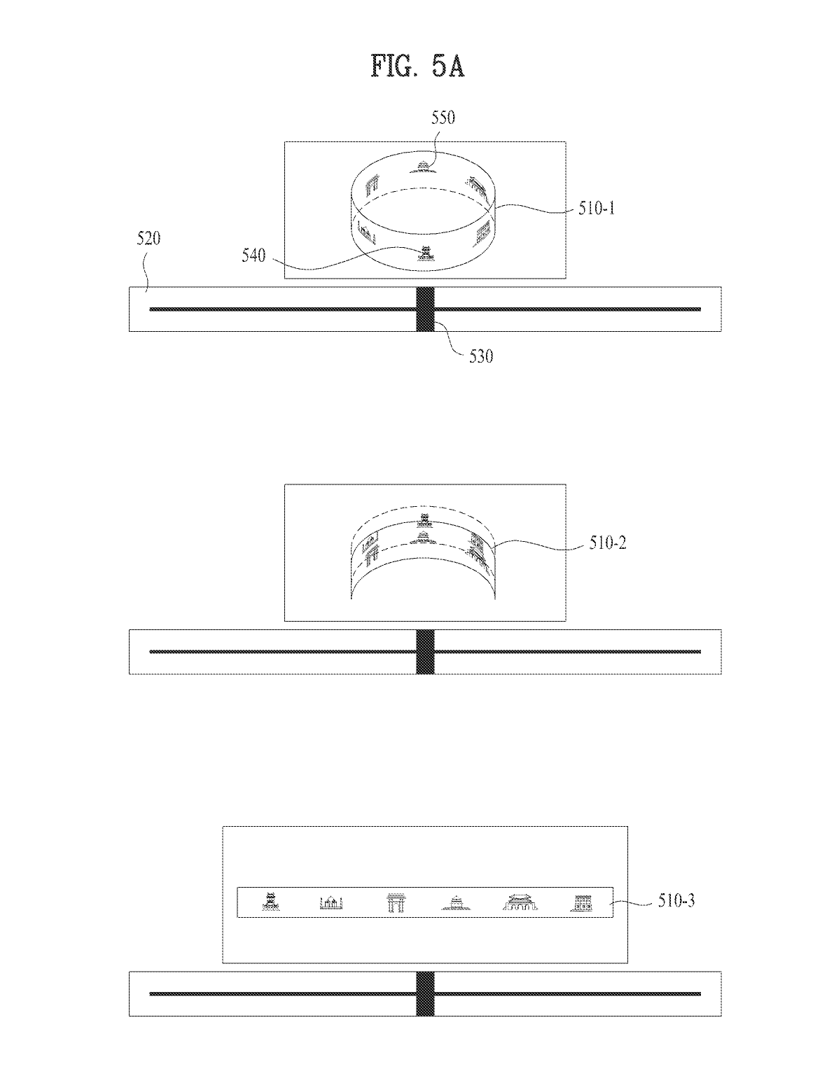

The processor 130 may display a thumbnail image related to a surround video image and a progress bar indicating a progress status of the surround video image. In this case, the thumbnail image may include a first image corresponding to a first region of the surround video image. And, the thumbnail image may include a second image corresponding to a second region of the surround video image. More specifically, if the front direction of the HMD device 100 corresponds to a first direction, the processor 130 may display the first region. And, if the front direction of the HMD device 100 corresponds to a second direction, the processor 130 may display the second region. In particular, the processor 130 may display a part of region of the surround video image based on the front direction of the HMD device 100. In case that the processor 130 displays the progress bar and the thumbnail image, the processor 130 may include the first image corresponding to the first region of the surround video image and the second image corresponding to the second region of the surround video image. As an example, the processor 130 may display an image corresponding to a whole region of the surround video image as a thumbnail image. Additionally, the processor 130 may display an image corresponding to a part of region of the surround video image as a thumbnail image. In particular, the processor 130 may display the thumbnail image corresponding to the surround video image. Regarding this, it shall be described later with reference to FIG. 4a to FIG. 4c.

FIG. 2a to FIG. 2c are diagrams for an image type of a surround video image according to one embodiment of the present specification.

The HMD device may detect a front direction of the HMD device using the sensor unit 110. As mentioned in the foregoing description, the HMD device 100 may detect the front direction of the HMD device 100 based on a reference direction. In this case, the HMD device 100 may display a part of a surround video image based on the front direction of the HMD device 100.

In this case, the surround video image may correspond to an image unfolded to a prescribed direction (e.g., a front, a rear, a left, a right, a top, or a bottom direction) on the basis of the HMD device 100. In particular, the HMD device 100 detects a direction at which a face of a user is facing as the front direction of the HMD device 100 and may be then able to provide a surround video image corresponding to the direction to the user. By doing so, the HMD may provide a more realistic virtual environment to the user.

Additionally, the HMD device 100 may display a surround video image based on an image type of the surround video image. In this case, as an example, the image type may be determined based on a region which is displayed according to the front direction of the HMD device 100. More specifically, the HMD device 100 may display a part of the surround video image in a prescribed direction on the basis of the HMD device 100.

As an example, referring to FIG. 2a, the surround video image may correspond to a cylinder image type 220 which provides an image to all directions of a horizontal direction of the HMD device 100. In this case, the HMD device 100 may form the surround video image for bearings of 360 degrees in horizontal direction from the front of the HMD device 100. In particular, the surround video image may correspond to an image of a cylinder form when the surround video image is seen from external.

Additionally, as an example, referring to FIG. 2b, the surround video image may correspond to a hemisphere image type 230 which provides an image to all directions of a horizontal direction and all directions of a vertical direction above a horizontal plane of the HMD device 100. In this case, the HMD device 100 may provide the surround video image to the bearings of 360 degrees in horizontal direction from the front of the HMD device 100. Additionally, the HMD device 100 may provide the image to all directions above the horizontal plane of the HMD device 100. In particular, the surround video image may correspond to an image of a hemisphere form when the surround video image is seen from external.

Additionally, as an example, referring to FIG. 2c, the surround video image may correspond to a sphere image type 240 which provides an image to all directions of a horizontal direction and all directions of a vertical direction of the HMD device 100. In this case, the HMD device 100 may provide the surround video image to the bearings of 360 degrees in horizontal direction from the front of the HMD device 100. Additionally, the HMD device 100 may provide the surround video image to the bearings of 360 degrees in vertical direction from the front of the HMD device 100. In particular, the surround video image may correspond to an image of a sphere form when the surround video image is seen from external.

In particular, the image type of the surround video image may be determined based on a region in which the image is displayed in the horizontal direction or the vertical direction of the front direction of the HMD device 100. The surround video image may correspond to a video image which is modified according to the front direction of the HMD device 100, by which the present specification may be non-limited. In particular, if the front direction of the HMD device 100 changes, the HMD device 100 may display a part of the surround video image for the user. In this case, the HMD device 100 may display regions different from each other of the surround video image in accordance with the front direction of the HMD device 100.

FIG. 3 is a diagram for a region displayed according to a front direction of an HMD device among a surround video image according to one embodiment of the present specification.

If the front direction of the HMD device 100 corresponds to a first direction, the HMD device 100 may display a first region 320. If the front direction of the HMD device 100 corresponds to a second direction, the HMD device 100 may display a second region 330.

More specifically, the HMD device 100 may display a part of a surround video image 310 based on the front direction of the HMD device 100. In this case, as mentioned in the foregoing description, the HMD device 100 may detect the front direction of the HMD device 100 based on a reference direction. Additionally, as an example, the reference direction may correspond to a front direction of a user on timing that the HMD device 100 displays the surround video image 310. The HMD device 100 may detect that the front direction of the HMD device 100 corresponds to the first direction. In this case, the HMD device 100 may display the first region 320 corresponding to the first direction among the surround video image 310. As an example, the HMD device may set up the reference direction corresponding to the front direction of the user as the first direction when the HMD device 100 displays the surround video image 310. In this case, the HMD device 100 may display the first region 320 corresponding to the first direction. Subsequently, the HMD device 100 may detect that the front direction of the HMD device 100 changes from the reference direction to a second direction. In this case, as an example, the second direction may correspond to a direction that the user turns the user's head to 90 degrees from the reference direction. The HMD device 100 may display the second region 330 corresponding to the second direction. In particular, the HMD device 100 may display a part of the surround video image 310 in response to the front direction of the HMD device 100.

FIG. 4a to FIG. 4c are diagrams of a method for an HMD device according to one embodiment of the present specification to display a thumbnail image based on an image type of a surround video image.

As mentioned in the foregoing description, the surround video image may correspond to at least one selected from the group consisting of a cylinder image type 220, a hemisphere image type 230 and a sphere image type 240. In this case, the HMD device 100 may display a thumbnail image related to the surround video image and a progress bar indicating a progress status of the surround video image. Additionally, the HMD device 100 may display the surround video image. As an example, the HMD device 100 may display the surround video image while a surround video content is playing.

The HMD device 100 may display a thumbnail image based on an image type of the surround video image related to the thumbnail image. More specifically, the HMD device 100 may display the thumbnail image including a form identical to the image type of the surround video image. In particular, the HMD device 100 may display the surround video image as the thumbnail image in a manner of reducing the surround video image with a predetermined ratio. In this case, the thumbnail image may include a first image 420-2 corresponding to a first region 420-1 of the surround video image and a second image 430-2 corresponding to a second region 430-1 of the surround video image. More specifically, the thumbnail image may correspond to an image corresponding to a whole region included in the surround video image. Additionally, as an example, the thumbnail image may correspond to an image corresponding to a part of the surround video image, by which the present specification may be non-limited.

Additionally, the HMD device 100 may display the thumbnail image based on time information within the surround video image. More specifically, the thumbnail image may include the time information within the surround video image. In this case, the time information may correspond to information on timing of displaying the thumbnail image in the surround video image. In this case, the HMD device 100 may display the thumbnail image in a position corresponding to the time information of a progress bar 440. Additionally, as an example, the HMD device 100 may display a plurality of thumbnail images. More specifically, the HMD device 100 may display the thumbnail image in a position at which an indicator is positioned in the progress bar 440. Additionally, the HMD device 100 may display a plurality of the thumbnail images based on a prescribed time interval in the progress bar 440, by which the present specification may be non-limited.

As an example, referring to FIG. 4a and FIG. 4c, in case that the surround video image corresponds to the cylinder image type 220, the HMD device 100 may display a first thumbnail image 410-1 of a cylinder form. In this case, the thumbnail image may include the first image 420-2 corresponding to the first region 420-1 and the second image 430-2 corresponding to the second region 430-1. Additionally, the HMD device 100 may display the thumbnail image adjacent to the indicator 450 of the progress bar 440. In this case, the indicator 450 may be displayed in a position corresponding to time information within the surround video image. The HMD device 100 may display the thumbnail image identical to the surround video image in response to the time information of the surround video image.

Additionally, referring to FIG. 4b, in case that the surround video image corresponds to the hemisphere image type 230, the HMD device 100 may display a second thumbnail image 410-2 of a hemisphere form. In this case, the thumbnail image may include the first image 420-2 corresponding to the first region 420-1 and the second image 430-2 corresponding to the second region 430-1.

Additionally, referring to FIG. 4c, in case that the surround video image corresponds to the sphere image type 240, the HMD device 100 may display a third thumbnail image 410-3 of a sphere form. In this case, the thumbnail image may include the first image 420-2 corresponding to the first region 420-1 of the surround video image and the second image 430-2 corresponding to the second region 430-1 of the surround video image.

In particular, the HMD device may display the thumbnail image based on the image type of the surround video image. In this case, if the image type of the surround video image changes, the HMD device 100 may display the thumbnail image based on the changed image type.

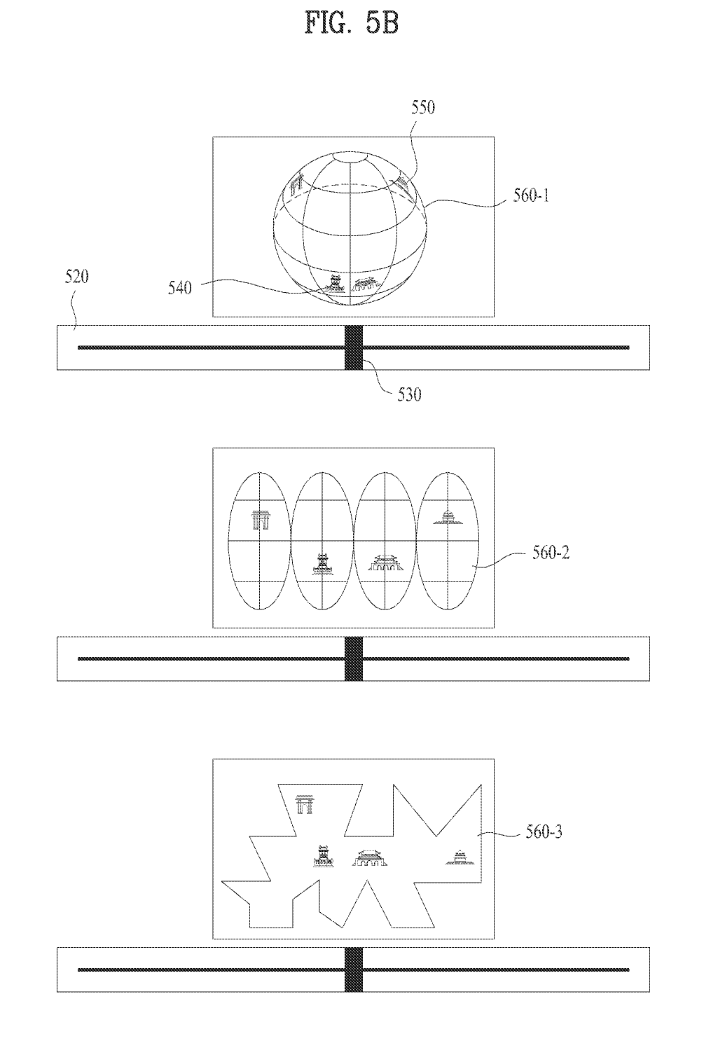

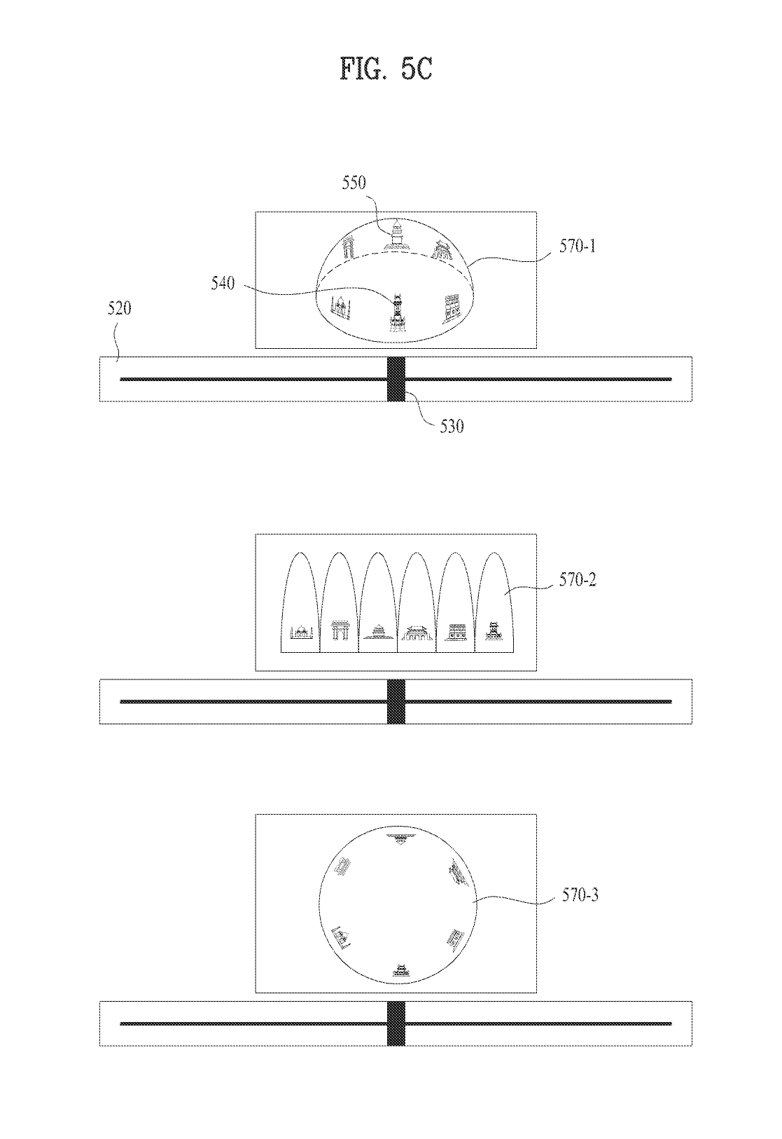

FIG. 5a to FIG. 5c are diagrams of a method for an HMD device according to one embodiment of the present specification to display a thumbnail image based on a display attribute of a thumbnail image.

The HMD device may display a thumbnail image based on a display attribute of the thumbnail image. In this case, the display attribute may include at least one selected from the group consisting of a shape, a size and a position of the thumbnail image to be displayed. More specifically, the display attribute of the thumbnail image may correspond to a form of the thumbnail image. The HMD device 100 may display the thumbnail image related to a surround video image. In this case, the HMD device 100 may display the thumbnail image of the surround video image including an identical image type in various forms.

As an example, referring to FIG. 5a, the HMD device 100 may display a thumbnail image for a surround video image of a cylinder type. In this case, the HMD device 100 may display a first thumbnail image 510-1 corresponding to the surround video image reduced by a predetermined ratio. In particular, the HMD device 100 may have a form identical to the surround video image.

Additionally, the HMD device 100 may display a second thumbnail image 510-2, which displays a first image 540 and a second image 550 in a manner of overlapping with each other. In this case, the first image 540 may correspond to an image corresponding to a first region of the surround video image. Additionally, the second image 550 may correspond to an image corresponding to a second region of the surround video image. In this case, the first region may correspond to a region displayed in a first direction corresponding to a prescribed direction among directions within a threshold range on the basis of a front direction of a user in the surround video image. Additionally, the second region may correspond to a region displayed in a second direction corresponding to a prescribed direction among directions within the threshold range on the basis of a rear direction of the user in the surround video image. In this case, as an example, the HMD device 100 may determine the front direction and the rear direction of the user based on the aforementioned reference direction. More specifically, the first region may correspond to a region located at the front of a part in which the reference direction is determined on the basis of the HMD device 100 and the second region may correspond to a region located at the rear of the part in which the reference direction is determined on the basis of the HMD device 100.

Additionally, as an example, the first region may correspond to a part of the surround video image corresponding to time information identical to the second region. More specifically, the HMD device 100 may sequentially display images in response to the time information of the surround video image. In particular, the first region and the second region may correspond to regions which are changed by the front direction of the HMD device 100 only in response to the identical time information.

The HMD device 100 may display the first image 540 corresponding to the first region and the second image 550 corresponding to the second region in a manner of overlapping the images with each other. In this case, the HMD device 100 may display the second image 550 at the back of the first image 540. Additionally, as an example, in case that the HMD device 100 displays the first image 540 and the second image in a manner of overlapping the images with each other, the HMD device 100 may transparently display the first image 540 which is displayed at the front of the second image 550.

Additionally, the HMD device 100 may display a third thumbnail image 510-3 corresponding to a planar figure of the unfolded surround video image. More specifically, the HMD device 100 may display an image, which is reduced from the planar figure of the unfolded surround video image of the cylinder form by a reference ratio, as a thumbnail image.

Additionally, as an example, referring to FIG. 5b, the HMD device 100 may display a thumbnail image for a surround video image of a sphere image type. In this case, the HMD device may display a first thumbnail image 560-1, which is reduced from the surround video image by the reference ratio. In particular, the HMD device 100 may have a form identical to the surround video image.

Additionally, the HMD device 100 may display a second thumbnail image 560-2 corresponding to a planar figure image of the unfolded surround video image. In this case, the second thumbnail image 560-2 may correspond to an image of the surround video image unfolded to a globe form.

Additionally, the HMD device 100 may display a third thumbnail image 560-3 corresponding to a planar figure image of the surround video image unfolded to an icosahedron.

In this case, the thumbnail image may include the first image 540 corresponding to the first region and the second image 550 corresponding to the second region.

Additionally, as an example, referring to FIG. 5c, the HMD device 100 may display a thumbnail image for a surround video image of a hemisphere image type. In this case, the HMD device may display a first thumbnail image 570-1, which is reduced from the surround video image by a predetermined ratio. In particular, the HMD device 100 may have a form identical to the surround video image.

Additionally, the HMD device 100 may display a second thumbnail image 570-2 corresponding to a planar figure image of the unfolded surround video image. In this case, the second thumbnail image 570-2 may correspond to an image of the surround video image unfolded to a globe form. The second thumbnail image may correspond to a planar figure of a hemisphere.

Additionally, the HMD device 100 may display a thumbnail image base on a direction of a gaze facing the surround video image. As an example, the HMD device 100 may display a third thumbnail image 570-3 in a form that the surround video image is seen from the top. In particular, the third thumbnail image 570-3 may be displayed in a circle shape.

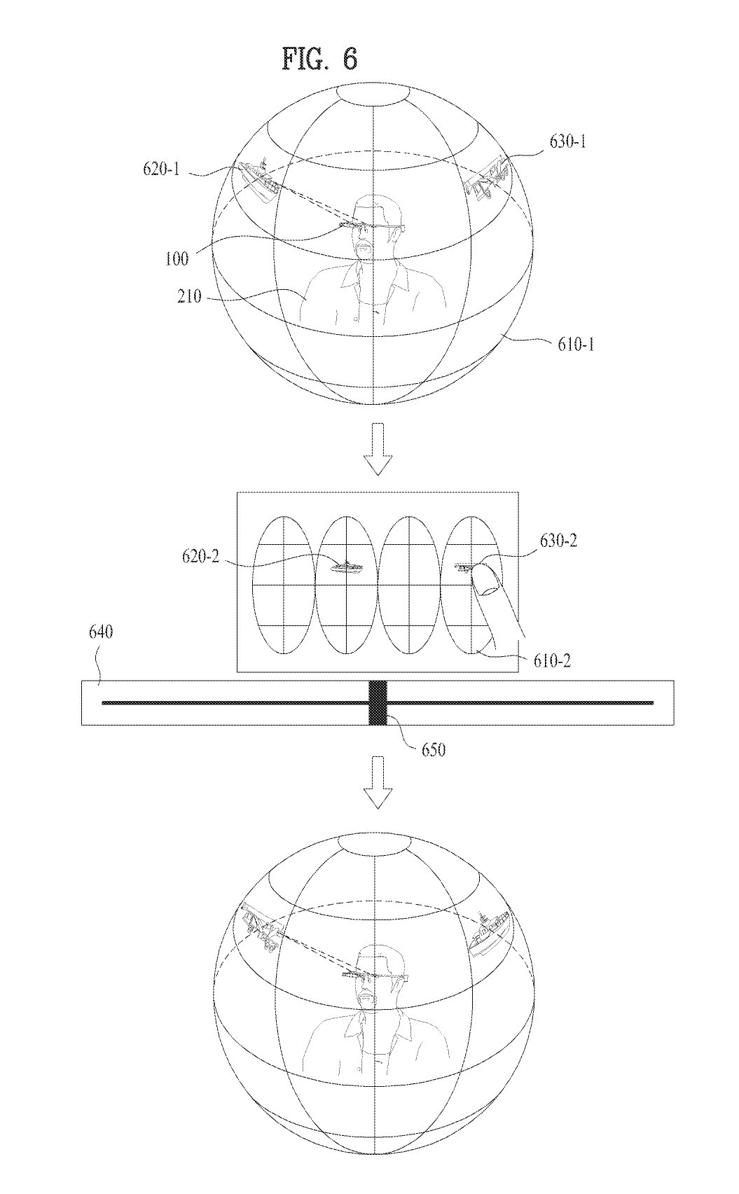

FIG. 6 is a diagram of a method for an HMD device according to one embodiment of the present specification to change a region displayed in a front direction of the HMD device based on a control input.

The HMD device 100 detects a control input using the sensor unit 110 and may deliver the detected control input to the processor. In this case, as mentioned in the foregoing description, the control input may correspond to at least one selected from the group consisting of a gesture input, a touch input, an audio input and an input inputted by an input device. Additionally, the control input may correspond to an input for controlling a thumbnail image displayed in the HMD device 100. More specifically, the HMD device 100 detects the control input for the thumbnail image and may control a surround video image corresponding to the thumbnail image based on the detected control input. As an example, referring to FIG. 6, the HMD device 100 may display a surround video image 610-1, a thumbnail image 610-2 and a progress bar 640. In this case, the HMD device 100 may display a first region 620-1 among the surround video image 610-1. Additionally, the HMD device 100 may display the thumbnail image 610-2 corresponding to the surround video image as a planar figure image. In this case, the thumbnail image 610-2 may include a first image 620-2 corresponding to the first region 620-1 of the surround video image 610-1. Additionally, the thumbnail image 610-2 may include a second image 630-2 corresponding to a second region 630-1 of the surround video image 610-1. Additionally, the HMD device 100 may display the thumbnail image 610-2 adjacent to an indicator 650 indicating time information of the surround video image 610-1 in the progress bar 640. In this case, the HMD device 100 may detect a control input for selecting the second image 630-2 from the thumbnail image 610-2. The HMD device 100 may display the second region 630-1 among the surround video image based on the detected control input. As an example, if the front direction of the HMD device 100 corresponds to the reference direction, the HMD device 100 may display the first region 620-1. In this case, the HMD device 100 may display the second region 630-1 based on the aforementioned control input instead of the first region 620-1 which is used to be displayed. In particular, the HMD device 100 may change a displayed region among the surround video image without changing the front direction of the HMD device 100.

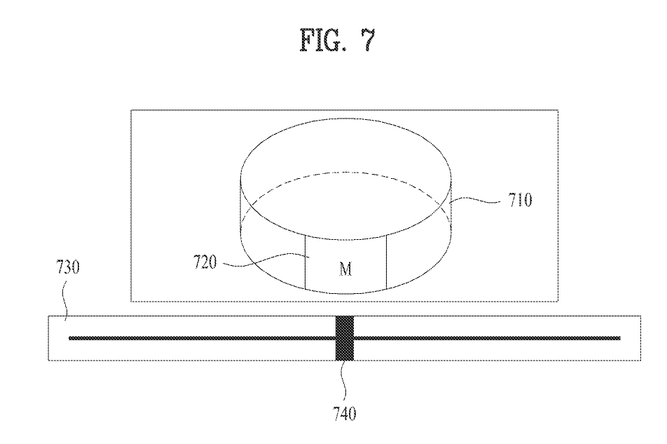

FIG. 7 is a diagram of a method for an HMD device according to one embodiment of the present specification to display a thumbnail image including a main region.

A thumbnail image 710 may include a main region 720 and a sub region. In this case, the main region 720 may correspond to a representative region of the thumbnail image 710. Additionally, as an example, the HMD device 100 may display an indicator 740 indicating time information in a progress bar 730. In this case, the HMD device 100 may display the main region most adjacent to the indicator 740 among the thumbnail image 710. Additionally, the HMD device 100 may set up a region at which most of gazes are arriving as the main region among the thumbnail image 710. Additionally, the main region 720 can be determined by a user or the HMD device 100, by which the present specification may be non-limited.

Additionally, the HMD device 100 may include a main image. In this case, the main image may correspond to a representative image of a thumbnail image. Additionally, the main image may correspond to an image corresponding to a displayed region when a front direction of the HMD device 100 corresponds to a direction at which a user is facing among the surround video image. More specifically, the HMD device 100 sets up the aforementioned reference direction and may detect the front direction of the HMD device 100 based on the reference direction. In this case, as an example, the HMD device 100 sets up the front direction of the HMD device on timing that the user wears the HMD device 100 as the reference direction and may set up it as the front direction of the user. In this case, the HMD device 100 may set up an image corresponding to the region displayed in the front direction of the user as the main image of the thumbnail image among the surround video image. Additionally, as an example, the HMD device 100 may set up an image corresponding to a representative region of the surround video image as the main image. Additionally, the main image can be differently determined by the user or the HMD device 100, by which the present specification may be non-limited.

As an example, in case that the HMD device 100 displays the thumbnail image 710, the HMD device 100 may display a main image in a main region of the thumbnail image 710. In particular, the HMD device 100 may display the main image in the main region as a representative image of the surround video image.

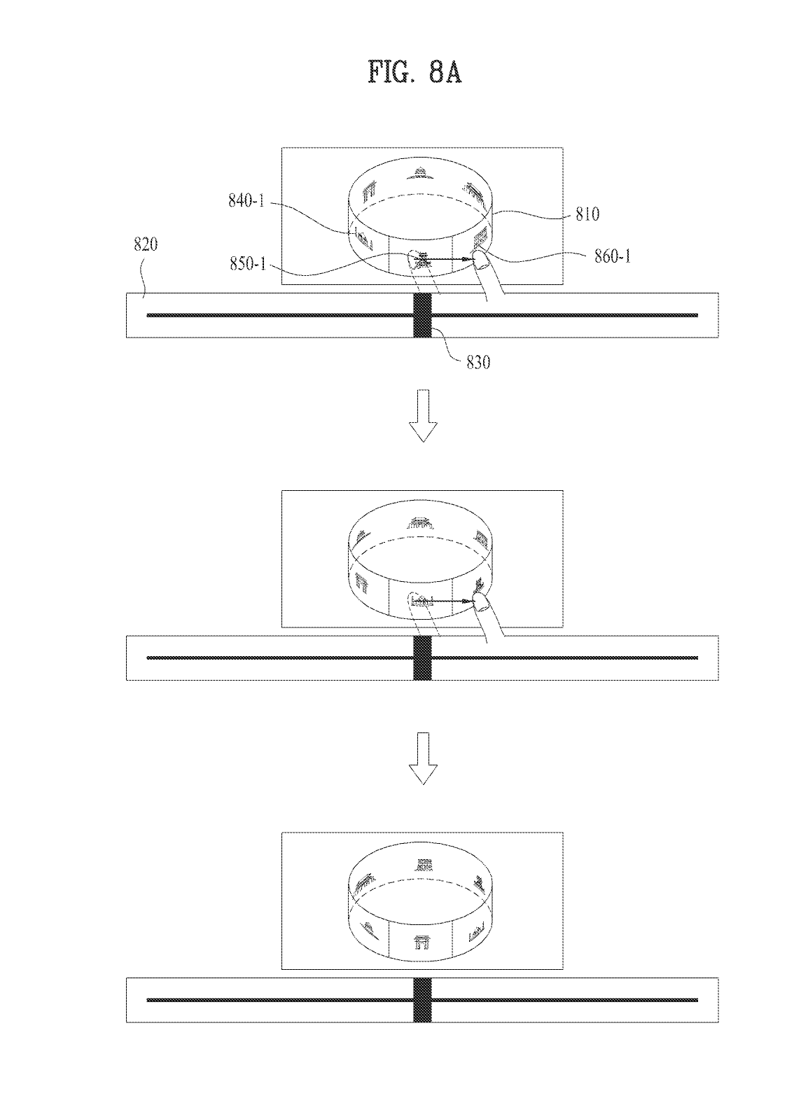

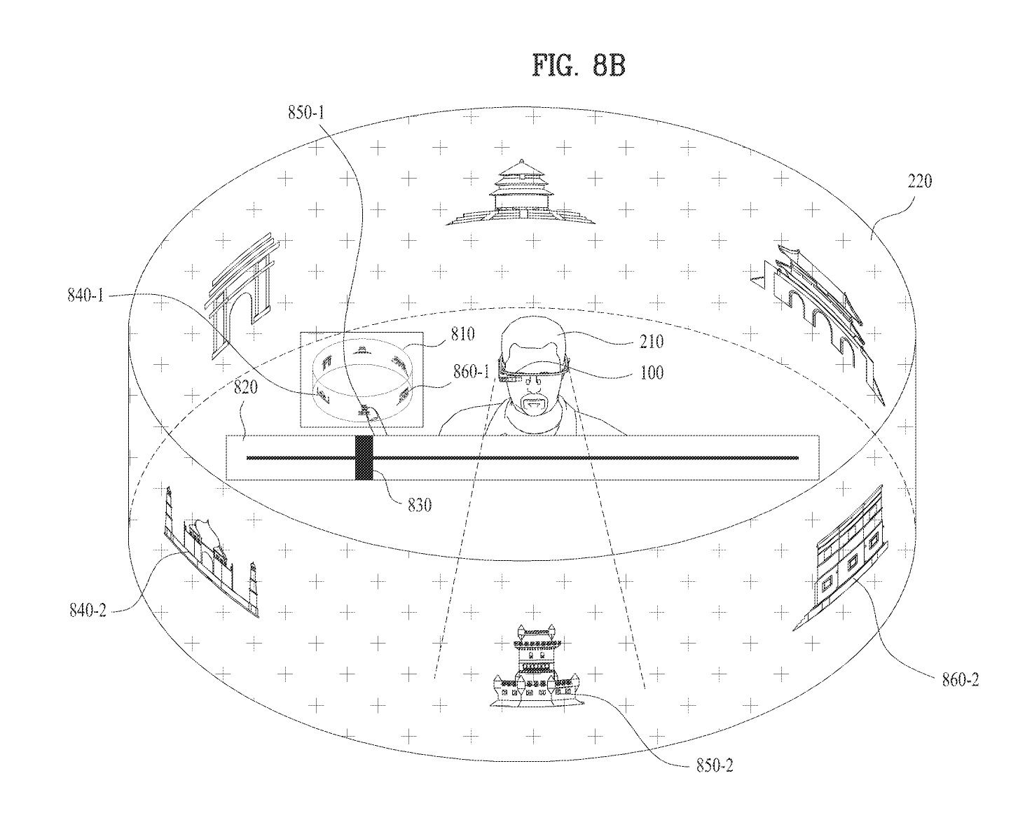

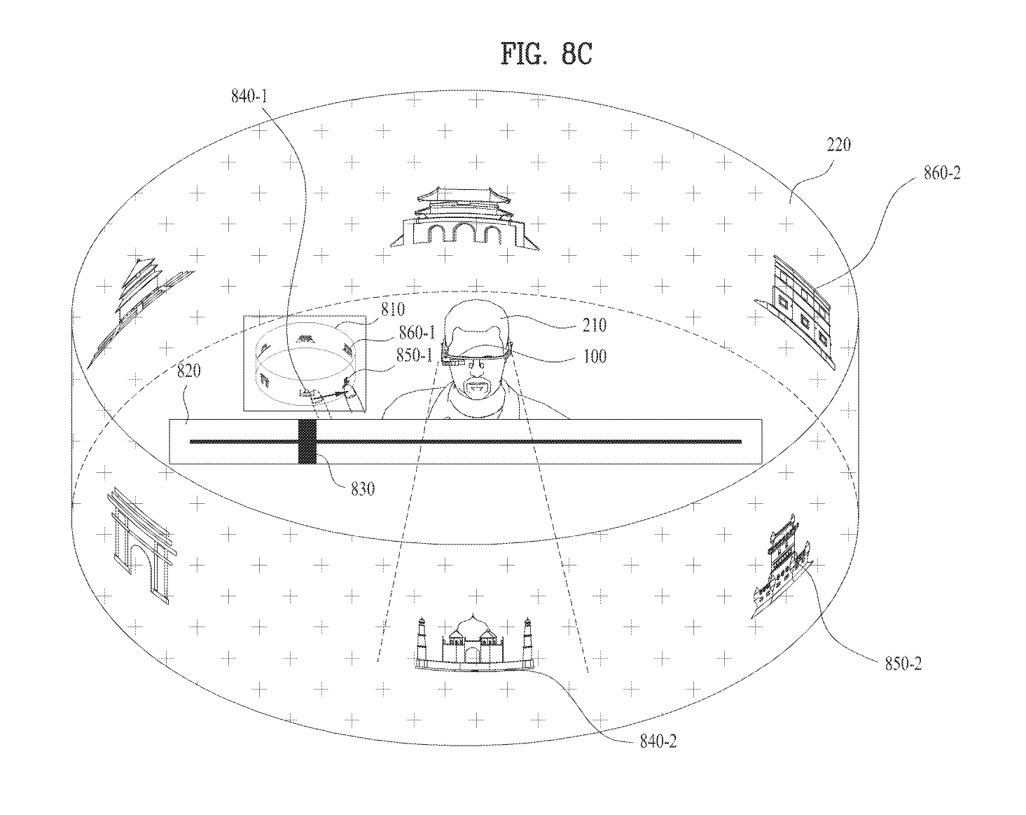

FIG. 8a to FIG. 8c are diagrams of a method for an HMD device according to one embodiment of the present specification to change an image displayed in a main region. If the HMD device 100 detects that a front direction of the HMD device 100 corresponds to a first direction, the HMD device 100 may display a first region. Subsequently, the HMD device 100 may display a thumbnail image 810. In this case, the thumbnail image 810 may include a first image 850-1 corresponding to the first region. Additionally, the HMD device 100 may display the first image 850-1 in a main region of the thumbnail image. In particular, the HMD device 100 may display an image corresponding to a region watched by a user in the main region of the thumbnail image 810.

Additionally, the HMD device 100 may detect a control input for rotating the thumbnail image 810 in a state that the first image 850-1 is displayed in the main region of the thumbnail image 810. In this case, the control input may correspond to a slide touch input or a gesture input, by which the present specification may be non-limited. In case that the HMD device 100 detects the control input for rotating the thumbnail image 810, the HMD device 100 may display a second image 840-1 in the main region of the thumbnail image. In this case, the second image 840-1 may correspond to an image adjacent to the first image 850-1. In particular, the HMD device 100 may change the image displayed in the main region using the control input in the state that the thumbnail image 810 is displayed.

Additionally, as an example, in case that the HMD device displays the thumbnail image 810 and cannot detect the control input for more than a time threshold, the HMD device 100 may change the first image 850-1 displayed in the main region to the second image 840-1. In particular, if the HMD device 100 cannot detect the control input for more than the time threshold, the HMD device may rotate the thumbnail image 810. By doing so, the HMD device 100 may change the image displayed in the main region of the thumbnail image 810.

Additionally, as an example, the HMD device 100 may display the thumbnail image 810, a progress bar 820 and the surround video image at the same time. The HMD device 100 may detect a control input for selecting the first image 850-1 of the thumbnail image 810. In this case, the HMD device 100 may display a first region 850-2 of the surround video image corresponding to the first image 850-1. In particular, the HMD device 100 may control the surround video image 220 corresponding to the thumbnail image using the thumbnail image 810.

Additionally, as an example, the HMD device 100 may detect a control input for rotating the thumbnail image 810 in a state that the first image 850-1 is displayed in the main region of the thumbnail image 810. In case that the HMD device 100 detects the control input for rotating the thumbnail image 810, the HMD device 100 may display a second image 840-1 in the main region of the thumbnail image. In this case, the HMD device 100 may display a second region 840-2 of the surround video image corresponding to the second image 840-1. In this case, the second region 840-2 may correspond to a region adjacent to the first region 850-2.

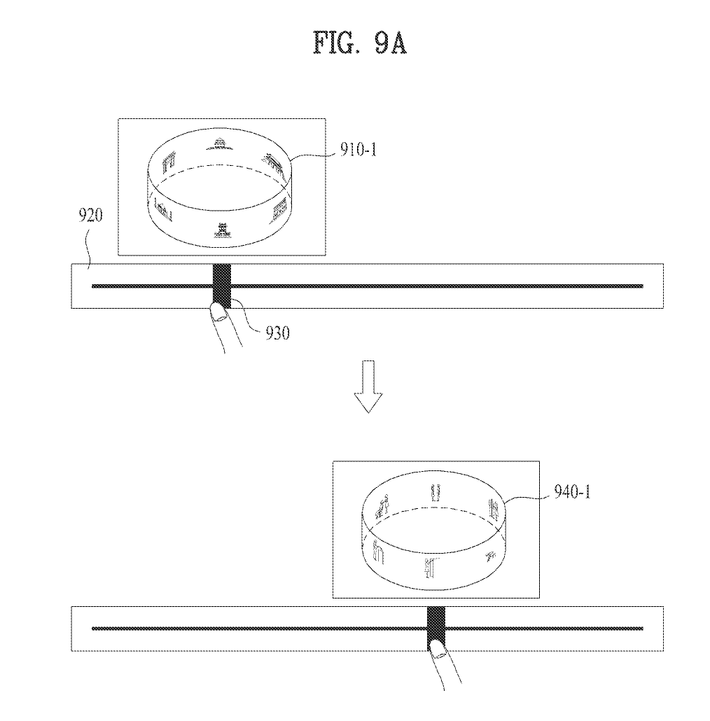

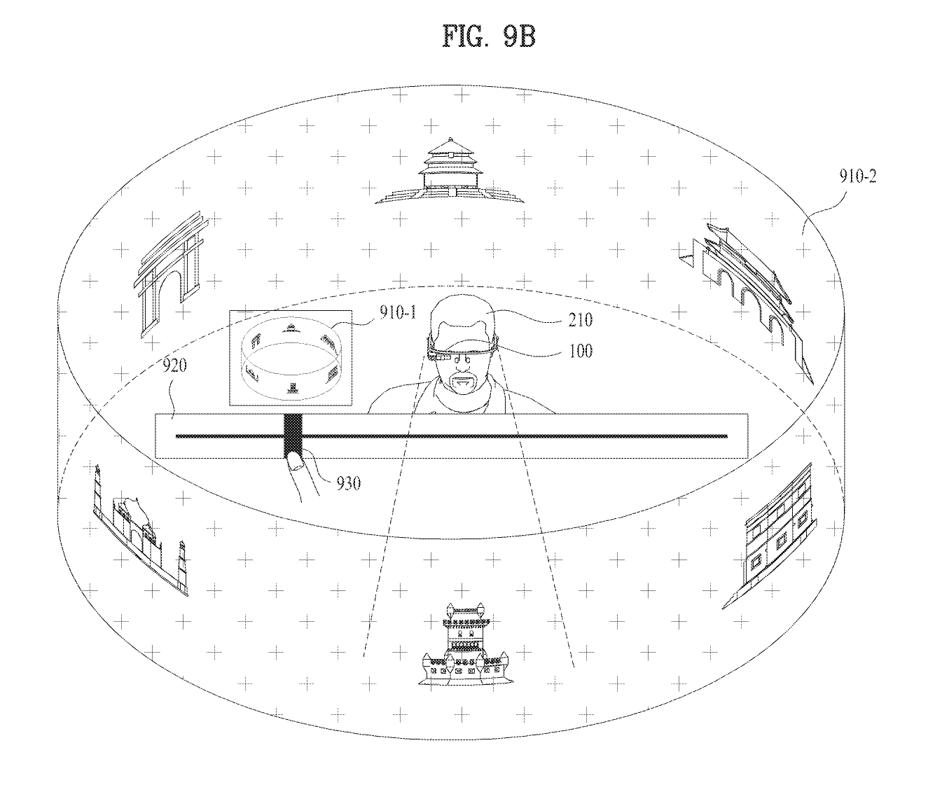

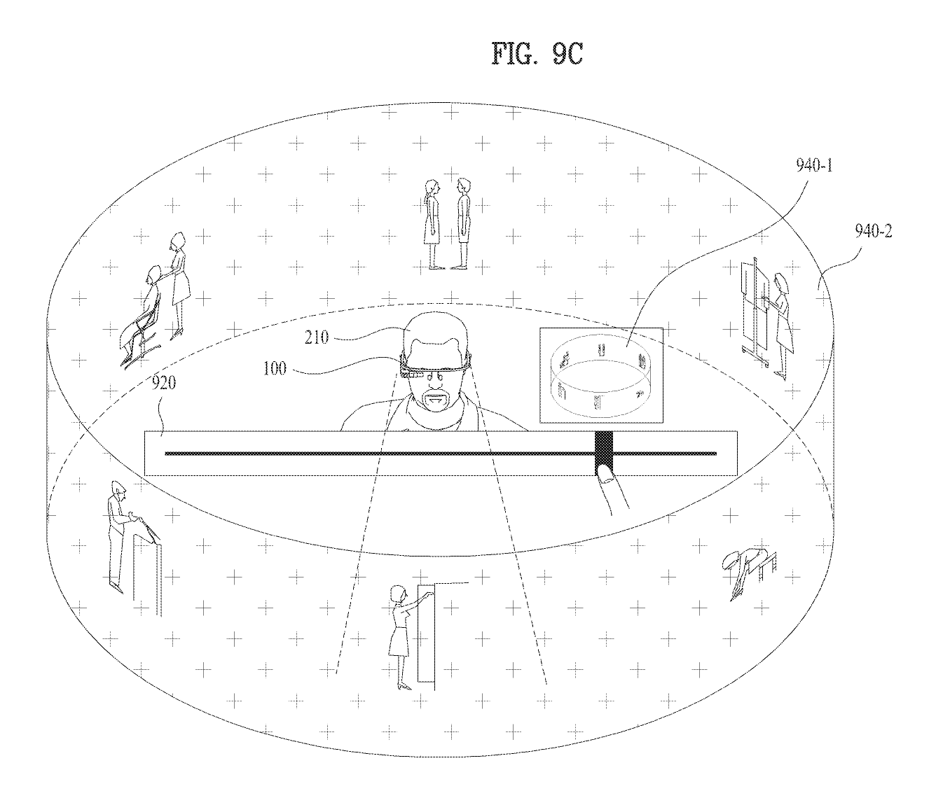

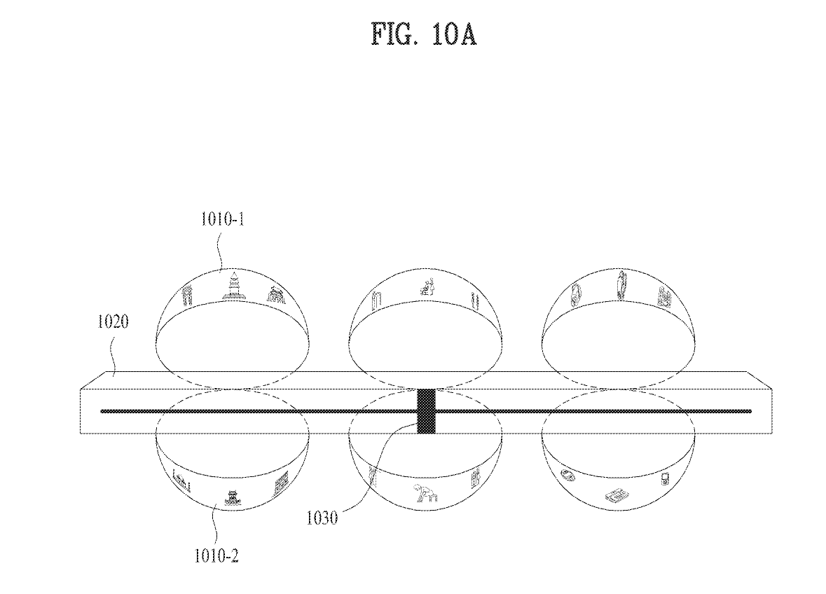

FIG. 9a to FIG. 9c are diagrams of a method for an HMD device according to one embodiment of the present specification to display a thumbnail image adjacent to a progress bar based on time information of the thumbnail image.

The HMD device 100 may display a thumbnail image adjacent to a progress bar. In this case, the thumbnail image may include time information of a surround video image corresponding to the thumbnail image. Additionally, the HMD device 100 may display the thumbnail image in a position corresponding to the time information adjacent to the progress bar. In this case, as an example, the HMD device 100 may display the thumbnail image adjacent to an indicator indicating the time information. Additionally, as an example, the HMD device 100 may display a plurality of thumbnail images, by which the present specification may be non-limited.

Additionally, the HMD device 100 may display the surround video image using a control input for selecting the thumbnail image which is displayed in response to the time information.

More specifically, as an example, the HMD device 100 may display a first thumbnail image 910-1 adjacent to a progress bar 920 as a position corresponding to a first time information. In this case, if the HMD device 100 detects a control input for moving an indicator 930 to a position corresponding to the first time information in the progress bar 920, the HMD device 100 may display a first surround video image 910-2 related to the first thumbnail image 910-1.

Additionally, as an example, if the HMD device 100 detects a control input for moving the indicator 930 to a position corresponding to a second time information in the progress bar 920, the HMD device 100 may display a second surround video image 940-2 related to a second thumbnail image 940-1.

In particular, the HMD device 100 may control the thumbnail image and the surround video image using the progress bar 920 and the indicator 930.

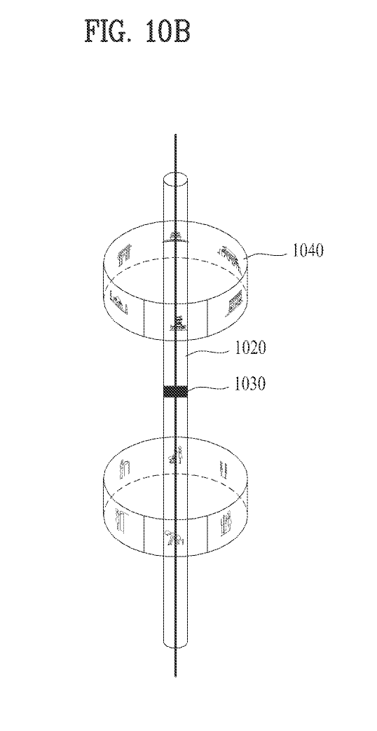

FIG. 10a and FIG. 10b are diagrams of a method for an HMD device according to one embodiment of the present specification to display a thumbnail image based on a progress bar.

The HMD device 100 may display a thumbnail image adjacent to a progress bar. In this case, the HMD device 100 may display the thumbnail image based on a shape, a size or a position of the displayed the progress bar 1020. More specifically, the HMD device 100 may change the shape, the size or the position of the displayed progress bar. As an example, the HMD device 100 may display the progress bar 1020 in a horizontal or a vertical direction. Additionally, as an example, the HMD device 100 may display the progress bar 1020 in three dimensions. In particular, the HMD device 100 may control a method of displaying the progress bar 1020. In this case, the HMD device 100 may display the thumbnail image based on the progress bar 1020.

As an example, referring to FIG. 10a, the HMD device 100 displays a part of the thumbnail image adjacent to a first side of the progress bar 1020 and may display a part of the thumbnail image adjacent to a second side of the progress bar 1020. Additionally, as an example, the HMD device 100 displays a main region of the thumbnail image adjacent to the first side of the progress bar 1020 and may display a sub region of the thumbnail image adjacent to the second side of the progress bar.

More specifically, the HMD device 100 may display a thumbnail image. In this case, the HMD device 00 may display a first internal thumbnail image 1010-1 at the top of the progress bar 1020. Additionally, the HMD device 100 may display a second internal thumbnail image 1010-2 at the bottom of the progress bar 1020. In particular, the HMD device 100 may display the thumbnail image in a manner of dividing the thumbnail image into two on the basis of the progress bar.

Additionally, as an example, referring to FIG. 10b, the HMD device 100 may display the progress bar 1020 in a vertical direction. Additionally, as an example, the HMD device 100 may display a thumbnail image 1040 in a manner of making the thumbnail image surround the progress bar 1020. More specifically, the HMD device 100 may display the thumbnail image 1040 of a ring form on the basis of the progress bar 1020. In particular, the HMD device 100 may display the thumbnail image in consideration of the progress bar 1020, by which the present specification may be non-limited.

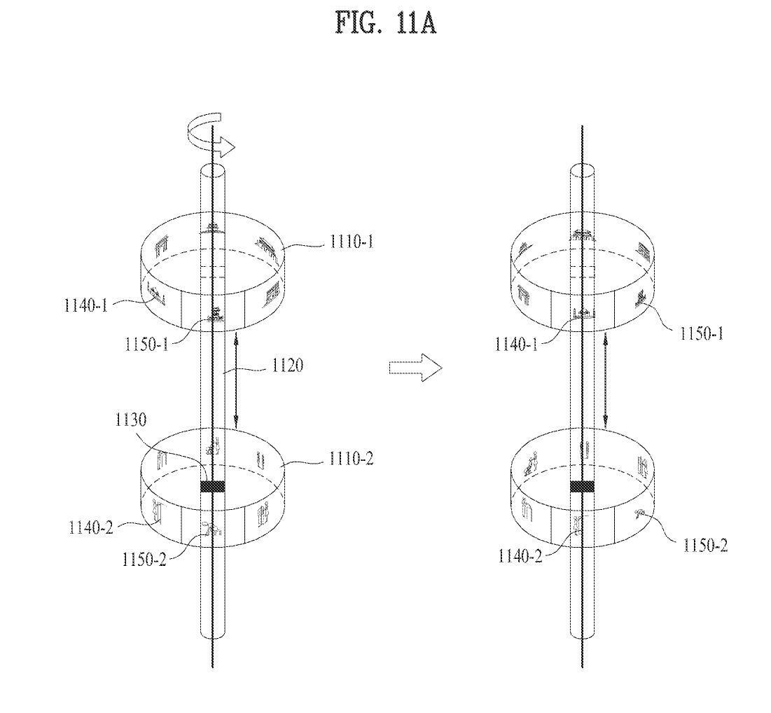

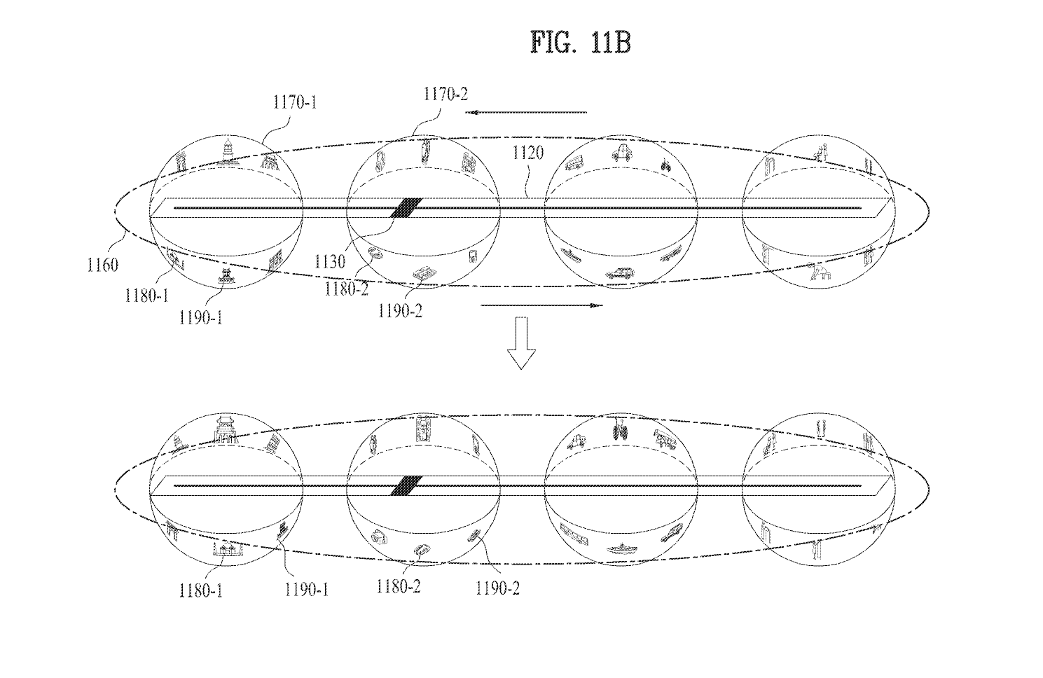

FIG. 11a and FIG. 11b are diagrams of a method for an HMD device according to one embodiment of the present specification to control a thumbnail image using a progress bar.

The HMD device 100 may execute a progress bar interface for controlling a progress bar 1120. In this case, the progress bar interface may correspond to an interface controlling the progress bar 1120 and a thumbnail image displayed adjacent to the progress bar. As an example, the progress bar interface may correspond to an interface for changing an image displayed in a main region among thumbnail images. Additionally, the progress bar interface may correspond to an interface controlling whether to display a thumbnail image. Additionally, the progress bar interface may correspond to an interface controlling an indicator 1130 corresponding to time information. In particular, the progress bar interface may correspond to an interface controlling the displayed progress bar 1120 and the thumbnail image.

In this case, as an example, referring to FIG. 11a, the progress bar interface may correspond to an interface for rotating the progress bar 1120 on the basis of a rotation axis. More specifically, the HMD device 100 may rotate the progress bar 1120 using the progress bar interface. In this case, the HMD device 100 may display a first image 1150-1 in a main region of a first thumbnail image 1110-1. Additionally, the HMD device may display a second image 1150-2 in a main region of a second thumbnail image 1110-2. Subsequently, if the HMD device 100 detects that the progress bar rotates on the basis of the rotation axis of the progress bar 1120, the HMD device 100 may display a third image 1140-1 in the main region of the first thumbnail image 1110-1. Additionally, the HMD device 100 may display a fourth image 1140-2 in the main region of the second thumbnail image 1110-2.

In particular, the HMD device 100 may change the image displayed in the main region of each of a plurality of the thumbnail images using the progress bar interface.

Additionally, as an example, referring to FIG. 11b, in case that the HMD device 100 executes the progress bar interface, the HMD device 100 may further display a ring progress bar 1160. In this case, the ring progress bar 1160 may correspond to an interface for controlling a thumbnail image. More specifically, the HMD device 100 may control an image displayed in a main region of the thumbnail image using the ring progress bar 1160. The HMD device 100 may display a first image 1190-1 in a main region of a first thumbnail image 1170-1. Additionally, the HMD device 100 may display a second image 1190-2 in a main region of a second thumbnail image 1170-2. In this case, if the HMD device 100 detects that the ring progress bar 1160 rotates, the HMD device 100 may display a third image 1180-1 in the main region of the first thumbnail image 1170-1. Additionally, the HMD device 100 may display a fourth image 1180-2 in the main region of the second thumbnail image 1170-2. In particular, the HMD device 100 may change the image displayed in the main region of each of a plurality of the thumbnail images using the ring progress bar 1160.

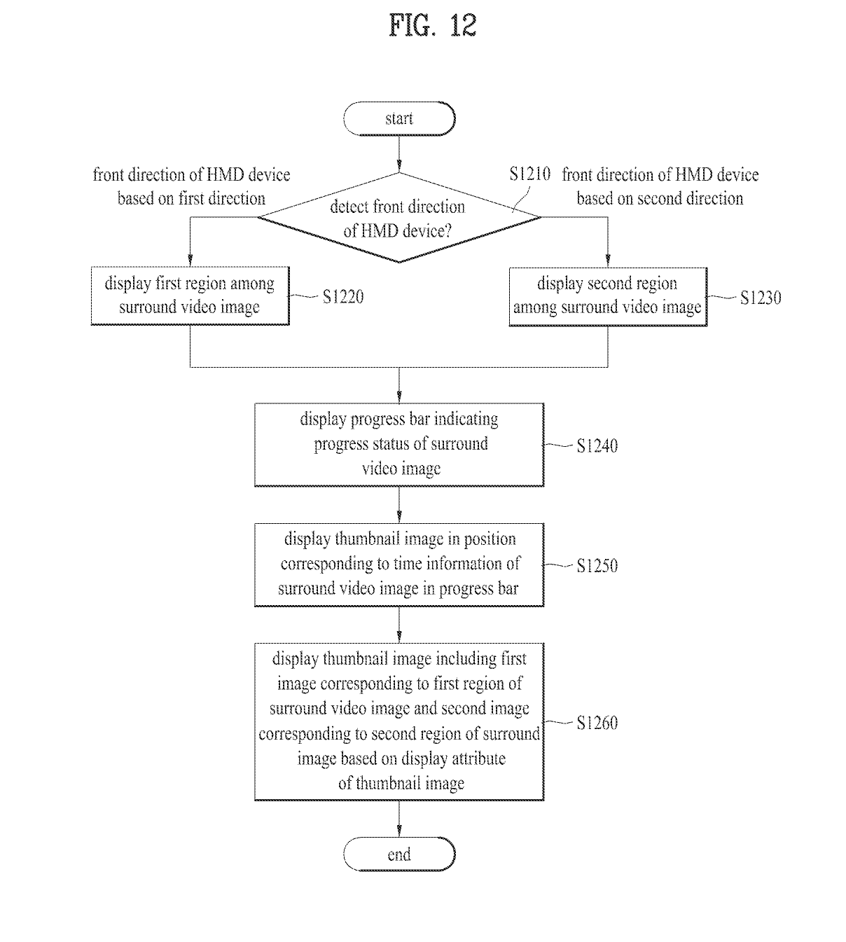

FIG. 12 is a flowchart for a method of controlling an HMD device according to one embodiment of the present specification.

The HMD device may detect a front direction of the HMD device 100 [S1210]. In this case, as mentioned earlier in FIG. 1, the front direction of the HMD device 100 is changed based on a movement of a user wearing the HMD device 100 and may be determined on the basis of the HMD device 100. More specifically, the front direction of the HMD device 100 may correspond to a direction at which the user is facing while wearing the HMD device 100. Additionally, the HMD device 100 may set up a reference direction for the front direction of the HMD device 100. The HMD device 100 may detect that the front direction of the HMD device 100 is changing based on the reference direction. As an example, if the user wears the HMD device 100 and displays a surround video image to watch a movie, the HMD device 100 may set up the front direction of the HMD device 100 of when the user displays the surround video image as the reference direction. In this case, if the user turns the user's head or moves, the HMD device 100 may detect that the front direction of the HMD device 100 is changing on the basis of the reference direction. In particular, the front direction of the HMD device 100 can be detected based on the reference direction. Additionally, the reference direction can be determined by the user or the HMD device 100, by which the present specification may be non-limited.

Subsequently, if the HMD device 100 detects that the front direction corresponds to a first direction, the HMD device 100 may display a first region among the surround video image [S1220]. Additionally, if the HMD device 100 detects that the front direction corresponds to a second direction, the HMD device 100 may display a second region among the surround video image [S1230]. As mentioned earlier in FIG. 2a to FIG. 2c, the HMD device 100 may display a part of the surround video image based on the front direction of the HMD device 100. In this case, the surround image may correspond to an image unfolded to a prescribed direction (e.g., a front, a rear, a left, a right, a top, or a bottom direction) on the basis of the HMD device 100. In particular, the HMD device 100 detects a direction at which the user is facing as the front direction of the HMD device 100 and may be then able to provide a surround image corresponding to the direction. In particular, the HMD device 100 may display a part of the surround video image based on the front direction.

Subsequently, the HMD device 100 may display a progress bar indicating a progress status of the surround video image [S1240]. As mentioned earlier in FIG. 1, the progress bar may indicate the progress status based on time information of the surround video image within surround video content. Additionally, as an example, the progress bar may display an indicator in a position corresponding to the time information of the surround video image. In this case, the progress bar may display the surround video image based on the time information of the point at which the indicator is positioned. In particular, the progress bar may include information on the progress status of the surround video image.

Subsequently, the HMD device 100 may display a thumbnail image in a position corresponding to the time information of the surround video image in the progress bar [S1250]. As mentioned earlier in FIG. 1, the thumbnail image may include time information within the surround video image. In this case, the display unit 120 may display the thumbnail image adjacent to the progress bar as a point corresponding to the time information included in the thumbnail image. Additionally, as an example, the display unit 120 may display the surround video image, the thumbnail image and the progress bar at the same time.

Subsequently, the HMD device 100 may display a first image corresponding to the first region of the surround video image and a thumbnail image including a second image corresponding to the second region of the surround video image based on a display attribute of the thumbnail image [S1260]. As mentioned earlier in FIGS. 5a to 5c, the HMD device 100 may display a thumbnail image based on a display attribute of the thumbnail image. In this case, the display attribute may include at least one selected from the group consisting of a shape of the thumbnail image, a size of the thumbnail image and a position in which the thumbnail image is displayed. More specifically, the display attribute of the thumbnail image may correspond to a form of the thumbnail image. The HMD device 100 may display a thumbnail image related to the surround video image. In this case, the HMD device 100 may display a thumbnail image of the surround video image including an identical image type in various forms.

For clarity of explanation, each diagram is explained in a manner of being divided. Yet, it is possible to design a new embodiment to implement the new embodiment by combining the embodiments, which are described in each of the diagrams. Additionally, according to the necessity of those skilled in the art, designing a recording media readable by the computer, which has recorded a program for executing the previously explained embodiments, also belongs to a scope of a right.

A HMD device 100 according to the present specification and a method of controlling therefor may not limitedly apply to the composition and method of the aforementioned embodiments. The aforementioned embodiments may be determined in a manner of being selectively combined the whole of the embodiments or a part of the embodiments to achieve various modifications.

Meanwhile, a HMD device 100 according to the present specification and a method of controlling therefor can be implemented with a code readable by a controller in a recording media readable by the controller, which is equipped in the device. The recording media readable by the controller may include all kinds of recording devices for storing data capable of being read by the controller. The examples of the recording media readable by the controller may include a ROM, a RAM, a magnetic tape, a floppy disc, an optical data storing device and the like. Additionally, implementing in a form of a carrier wave such as a transmission via the internet and the like is also included. Additionally, since the recording media readable by the processor are distributed to the computers connected by a network, codes readable by the processor can be stored and executed in a manner of being distributed.

While the present specification has been described and illustrated herein with reference to the preferred embodiments and diagrams thereof, the present specification may be non-limited to the aforementioned embodiments and it will be apparent to those skilled in the art that various modifications and variations can be made therein without departing from the spirit and scope of the present specification. Thus, it is intended that the present specification covers the modifications and variations of this invention that come within the scope of the appended claims and their equivalents.

Additionally, both an apparatus invention and a method invention are explained in the present specification and the explanation on both of the inventions can be complementally applied, if necessary.

1. A head mounted display (HMD) device, comprising:
a sensor to detect a front direction of the HMD device;
a display to display a part of a surround video image based on a front direction of the HMD device,
wherein the display displays a first region among the surround video image when the front direction of the HMD device corresponds to a first direction,
wherein the surround video image is an image provided around the HMD device,
wherein the surround video image comprises the first region and a second region which is not displayed when the first region is displayed, and
a processor to:
control the display to display a thumbnail image which is related to the surround video image based on an image type of the surround video image corresponding to at least one of a cylinder image type, a sphere image type or a hemisphere image type, and the thumbnail image is a downsized image of the surround video image with a reference ratio,
control the display to display a progress bar indicating a progress status of the surround video image,
wherein the thumbnail image comprises a first image corresponding to the first region of the surround video image and a second image corresponding to the second region of the surround video image, and
display the first image corresponding to the first region at a center of the thumbnail image when the thumbnail image is displayed after the first region of the surround video image is displayed.

2. (canceled)

3. The HMD device of claim 1, wherein the surround video image corresponds to at least one of:
the cylinder image type providing an image to all directions of a horizontal direction of the HMD device,
the sphere image type providing the image to all directions of the horizontal direction and a vertical direction of the HMD device, and
the hemisphere image type providing the image to all directions above a horizontal plane of the vertical direction and all directions of the horizontal direction of the HMD device.

4. The HMD device of claim 1, wherein the processor displays the thumbnail image based on a display attribute of the thumbnail image, and
wherein the display attribute corresponds to at least one of a shape of the thumbnail image, a size of the thumbnail image and a position in which the thumbnail image is displayed.

5. (canceled)

6. The HMD device of claim 1, wherein the thumbnail image corresponds to a planar figure image in which the surround video image is unfolded.

7. The HMD device of claim 1, wherein the processor controls the display to display the first image contained in the thumbnail image at the rear of the second image in a manner of overlapping the images with each other when the thumbnail images are displayed, and
wherein the second image displayed in front of the first image corresponds to a transparent image.

8. The HMD device of claim 1, wherein the first region of the surround video image corresponds to a region displayed in the first direction corresponding to a prescribed direction among directions within a threshold range on the basis of a front direction of a user, and
wherein the second region of the surround video image corresponds to a region displayed in the second direction corresponding to a prescribed direction among the directions within the threshold range on the basis of a rear direction of the user.

9. The HMD device of claim 1, wherein the thumbnail image comprises time information within the surround video image, and
wherein the processor controls the display to display the thumbnail image adjacent to the progress bar in a position corresponding to the time information.

10. The HMD device of claim 1, wherein each of the first region of the surround video image and the second region of the surround video image is a part of the surround video image corresponding to an identical time information.

11. The HMD device of claim 1, wherein the sensor detects a control input and delivers the detected control input to the processor.

12. (canceled)

13. The HMD device of claim 11, wherein the processor controls the display to display the first region corresponding to the first direction among the surround video image, and display the first image corresponding to the first region among the thumbnail image in the main region when the thumbnail image is displayed.

14. The HMD device of claim 11, wherein the processor controls the display to display the first image in the main region of the thumbnail image, and display the first region of the surround video image corresponding to the first image when the first control input for selecting the first image is detected.

15. The HMD device of claim 11,
wherein the processor controls the display to display the first image in the main region of the thumbnail image, and display the second image in the main region when a second control input for rotating the thumbnail image is detected, and
wherein the second image corresponds to an image adjacent to the first image.

16. The HMD device of claim 11, wherein the processor controls the display to display the first image in the main region of the thumbnail image, and display the second image in the main region, when the control input is not detected for more than a time threshold.

17. The HMD device of claim 11, wherein the thumbnail image comprises a main image of the surround video image, and
wherein the processor controls the display to display the main image in the main region of the thumbnail image when the thumbnail image is displayed.

18. The HMD device of claim 17, wherein the processor sets the main image as an image corresponding to a region which is displayed when the front direction of the HMD device corresponds to a front direction of a user among the surround video image.

19. The HMD device of claim 11, wherein the processor controls the display to display the main region adjacent to a first side of the progress bar and display the sub region adjacent to a second side corresponding to an opposite side of the first side.

20. The HMD device of claim 11, further comprising a progress bar interface to control the progress bar,
wherein the progress bar interface corresponds to an interface for rotating the progress bar on the basis of a rotation axis, and
wherein the processor controls the display to display the first image in the main region of the thumbnail image, and display the second image in the main region when the progress bar is rotated on the basis of the rotation axis based on the progress bar interface.

21. A method of controlling a head mounted display (HMD) device, the method comprising:
displaying a part of a surround video image, wherein if a front direction of the HMD device corresponds to a first direction, display a first region among the surround video image;
wherein the surround video image is an image provided around the HMD device, and
wherein the surround video image comprises the first region and a second region which is not displayed when the first region is displayed;
displaying a thumbnail image which is related to the surround video image based on an image type of the surround video image corresponding to at least one of a cylinder image type, a sphere image type or a hemisphere image type, and the thumbnail image is an downsized image of the surround video image with a reference ratio;
displaying a progress bar indicating a progress status of the surround video image,
wherein the thumbnail image comprises a first image corresponding to the first region of the surround video image and a second image corresponding to the second region of the surround video image; and
displaying the first image corresponding to the first region at a center of the thumbnail image when the thumbnail image is displayed after the first region of the surround video image is displayed.
